(19) United States
(12) Patent Application Publication
(10) Pub. No.: US 2024/0186499 A1
(43) Pub. Date: Jun. 6, 2024

(54) TITANIUM-CONTAINING OXIDE POWDER, NEGATIVE ELECTRODE ACTIVE MATERIAL COMPOSITION USING SAME, AND ALL-SOLID-STATE SECONDARY BATTERY

(71) Applicant: UBE Corporation, Ube-shi, Yamaguchi (JP)

(72) Inventors: Kei SHIMAMOTO, Ube-shi (JP); Takumi TAKENAKA, Sakai-shi (JP)

(73) Assignee: UBE Corporation, Ube-shi (JP)

(21) Appl. No.: 18/553,451

(22) PCT Filed: Mar. 31, 2022
(86) PCT No.: PCT/JP2022/016896

§ 371 Date: Sep. 29, 2023

(30) Foreign Application Priority Data
Mar. 31, 2021 (JP) 2021-059786

(51) Int. Cl. H01M 4/485; C01B 25/14; C01G 23/00; C01G 33/00; H01M 4/02; H01M 4/62; H01M 10/0562

(52) U.S. Cl. CPC H01M 4/485; C01B 25/14; C01G 23/005; C01G 33/00; H01M 4/62; H01M 10/0562; C01P 2006/12; C01P 2006/40; H01M 2004/021; H01M 2004/027; H01M 2300/008

(57) ABSTRACT

Provided is a titanium-containing oxide powder whose main component is a titanium-containing oxide represented by Li₄Ti₅O₁₂ or Ti_{1-X/2}Nb₂O_{7-X} (0≤X<2), the titanium-containing oxide powder containing the titanium-containing oxide particles and a solvate ionic liquid, the solvate ionic liquid comprising a Li salt and an organic solvent.

### TECHNICAL FIELD

The present invention relates to a negative electrode active material composition using a titanium-containing oxide powder and relates also to an all-solid-state secondary battery.

### BACKGROUND ART

In recent years, power storage devices, especially lithium batteries, have been widely used for small electronic devices such as mobile phones and laptop computers and electric vehicles and for power storage applications. In the present specification, the term lithium battery is used as a concept that also encompasses so-called lithium ion secondary batteries.

Currently commercially available lithium batteries are mainly composed of positive and negative electrodes that contain materials capable of absorbing and desorbing lithium, and a non-aqueous electrolytic solution that contains a lithium salt and a non-aqueous solvent. Examples of the non-aqueous solvent for use include cyclic carbonates such as ethylene carbonate (EC) and propylene carbonate (PC) and chain carbonates such as dimethyl carbonate (DMC) and diethyl carbonate (DEC). Lithium batteries use an electrolytic solution that contains such a flammable organic solvent and are therefore prone to liquid leakage and may ignite when short-circuited, and it is thus necessary to install a safety device to suppress the temperature rise during short-circuiting and a structure to prevent short-circuiting.

Under such circumstances, all-solid-state secondary batteries using an inorganic solid electrolyte instead of organic electrolytic solution are attracting attention. Since the positive electrode, negative electrode, and electrolyte of all-solid-state secondary batteries are all solid, they have the potential to remarkably improve the safety and reliability, which are the challenges for batteries using an organic electrolytic solution. It is also possible to simplify the safety device, thus enabling high energy density, and the all-solid-state secondary batteries are therefore expected to be applied to electric vehicles, large storage batteries, etc.

Unlike conventional lithium-ion secondary batteries that use an electrolytic solution, in all-solid-state secondary batteries, it is very important to form a good solid-solid interface and continuously maintain the interface from the viewpoint of achieving excellent ion conductivity and long-term cycle characteristics. Lithium titanate attracts attention for maintaining a good interface between the active material and the solid electrolyte. Lithium titanate is expected to maintain the interface between the active material and the solid electrolyte for a long period of time during charge/discharge because the volume change due to charge/discharge is very small. Lithium titanate is also attracting attention in its high safety because it has a high reaction potential and there is no risk of lithium electrodeposition. Patent Document 1 discloses an electrode that uses lithium titanate having a certain BET specific surface area and solid electrolyte particles smaller than the average particle diameter of the lithium titanate and reports that the contact between the lithium titanate and the solid electrolyte particles becomes better than prior art. Patent Document 2 discloses a solid battery using an electrode active material layer that contains an active material, a sulfide solid electrolyte, and a solvate ionic liquid, and also discloses that the ion conductivity is improved in an active material layer produced using silicon, a conductive auxiliary agent, and a composition A (composition obtained by mixing a sulfide solid electrolyte and a solvate ionic liquid in a specific ratio). In addition, in order to further increase the energy density, there has been a movement to utilize as a negative electrode active material a niobium-titanium composite oxide composed mainly of niobium titanate that is represented by a general formula TiNb₂O₇ and has a high energy density of 380 mAh/g. Patent Document 3 discloses an electrode mixture that contains a sulfide solid electrolyte and a general formula Ti_{1±α}Nb_{2±β}O_{7±γ} whose D50 (μm)/BET (m²/g) is 0.005 or more and 5.0 or less. According to Patent Document 3, it is disclosed that excellent charge/discharge efficiency can be obtained when applied as an electrode mixture for a solid battery.

### PRIOR ART DOCUMENTS

### Patent Documents

Patent Document 1: JP2012-243644A
Patent Document 2: JP2019-121455A
Patent Document 3: WO2021/049665

### DISCLOSURE OF INVENTION

### Problems to be Solved by Invention

By using the electrode of Patent Document 1, the contact between the lithium titanate powder and the solid electrolyte powder seems to become good to improve the battery characteristics of the all-solid-state secondary battery, but further improvement of the charge rate characteristics may be necessary. In particular, when lithium titanate particles having a relatively small average particle diameter and a large specific surface area are used, deterioration in battery characteristics is observed even in the configuration of Patent Document 1. This appears to be because a side reaction occurs between active sites on the lithium titanate surface and the solid electrolyte to form a high-resistance layer. On the other hand, the battery characteristics of an all-solid-state secondary battery seems to be improved by using an electrode mixture of Patent Document 3 composed of a titanium niobium composite oxide in which the ratio of D50 to the BET specific surface area is within a predetermined range and a sulfide solid electrolyte, but further improvement is necessary as for the charge rate characteristics. This appears to be because, as in the lithium titanate, a side reaction occurs between the active sites on the surface of the titanium-niobium composite oxide and the solid electrolyte to form a high-resistance layer. To solve the above problems, the present invention provides a titanium-containing oxide powder that can form a negative electrode layer excellent in the battery characteristics, especially in the charge rate characteristics, in an all-solid-state battery by preliminarily treating the active sites on the surface of a titanium-containing oxide to effectively suppress the reaction with the solid electrolyte, and also provides an all-solid-state secondary battery.

### Means for Solving Problems

As a result of intensive researches to suppress a side reaction between the active sites on the surface of the titanium-containing oxide and the solid electrolyte when using the highly reactive titanium-containing oxide powder having a relatively large specific surface area, the present inventors have found that by combining titanium-containing oxide particles with a solvate ionic liquid composed of a Li salt and an organic solvent, the active sites on the surface of the titanium-containing oxide can be inactivated to effectively suppress the reaction with the solid electrolyte, and have thus accomplished the present invention. By using the negative electrode active material composition including the titanium-containing oxide powder and the solid electrolyte in an all-solid-state secondary battery, it is possible to increase the initial discharge capacity and improve the charge rate characteristics. It should be noted that Patent Document 2 discloses that the negative electrode mixture layer contains a solvate ionic liquid, but nothing in the document describes suppressing the reaction between the titanium-containing oxide and the solid electrolyte. Moreover, in the case of using graphite, silicon, etc. described in Patent Document 2 which have a low reaction potential, reductive decomposition of the solvate ionic liquid occurs, and the excellent battery characteristics seen in the present invention may not be obtained. Furthermore, in the case of using a composition in which a sulfide inorganic solid electrolyte and a solvate ionic liquid are preliminarily mixed as described in Patent Document 2, even when a titanium-containing oxide is used as the negative electrode active material, the active sites on the surface of the titanium-containing oxide can not be completely inactivated, and the excellent battery characteristics seen in the present invention may not be obtained.

The present invention relates to a titanium-containing oxide powder suitable as a negative electrode material for an all-solid-state secondary battery, a negative electrode active material composition using the titanium-containing oxide powder, and an all-solid-state secondary battery.

That is, the present invention provides the following (1) to (14).
(1) A titanium-containing oxide powder whose main component is a titanium-containing oxide represented by Li₄Ti₅O₁₂ or Ti_{1-X/2}Nb₂O_{7-X} (0≤X<2),
the titanium-containing oxide powder containing the titanium-containing oxide particles and a solvate ionic liquid,
the solvate ionic liquid comprising a Li salt and an organic solvent.
(2) The titanium-containing oxide powder according to (1), wherein D50 of primary particles corresponding to a volume accumulation of 50% in a volume-based particle size distribution of the titanium-containing oxide powder is 0.5 μm or more, wherein the volume-based particle size distribution is measured by a laser diffraction scattering method.
(3) The titanium-containing oxide powder according to (1) or (2), wherein the titanium-containing oxide powder has a specific surface area of 1 m²/g or more and 10 m²/g or less.
(4) The titanium-containing oxide powder according to any one of (1) to (3), wherein Al is present on particle surfaces of the titanium-containing oxide powder.
(5) The titanium-containing oxide powder according to any one of (1) to (4), wherein the Li salt is at least one type of Li salt selected from LiPF₆, LiBF₄, LiN(SO₂F)₂, LiN(SO₂CF₃)₂, and LiN(SO₂C₂F₅)₂.
(6) The titanium-containing oxide powder according to any one of (1) to (4), wherein the Li salt comprises at least two types or more of Li salts selected from LiPF₆, LiBF₄, LiN(SO₂F)₂, LiN(SO₂CF₃)₂, and LiN(SO₂C₂F₅)₂.
(7) The titanium-containing oxide powder according to any one of (1) to (4), wherein the Li salt comprises at least one type of Li salt selected from LiPF₆, LiBF₄, LiN(SO₂F)₂, LiN(SO₂CF₃)₂, and LiN(SO₂C₂F₅)₂, and the Li salt further comprises at least one type of Li salt selected from a Li salt having an oxalic acid frame, a Li salt having a phosphoric acid frame, and a Li salt having an S═O group.
(8) The titanium-containing oxide powder according to any one of (1) to (7), wherein the organic solvent is an ether compound.
(9) The titanium-containing oxide powder according to any one of (1) to (8), wherein a molar ratio of the Li salt to the organic solvent is 0.3 or more and 2.5 or less.
(10) The titanium-containing oxide powder according to any one of (1) to (9), wherein a proportion of the solvate ionic liquid to the titanium-containing oxide powder is 0.1 mass % or more and 30 mass % or less.
(11) A negative electrode active material composition comprising: a titanium-containing oxide powder; and an inorganic solid electrolyte having conductivity for metal ions belonging to Group 1 of Periodic Table, wherein the titanium-containing oxide powder comprises the titanium-containing oxide powder according to any one of (1) to (10).
(12) The negative electrode active material composition according to (11), wherein the inorganic solid electrolyte is a sulfide inorganic solid electrolyte.
(13) The negative electrode active material composition according to (11) or (12), wherein a content of the inorganic solid electrolyte is 1 mass % or more and 50 mass % or less in the negative electrode active material composition.
(14) An all-solid-state secondary battery comprising a positive electrode layer, a negative electrode layer, and a solid electrolyte layer, wherein the negative electrode layer is a layer containing the negative electrode active material composition according to any one of (11) to (13).

### Effects of Invention

According to the present invention, the side reaction between the titanium-containing oxide and the solid electrolyte can be effectively suppressed, and it is therefore possible to obtain a negative electrode active material composition and an all-solid-state secondary battery that are excellent in the initial discharge capacity and the charge rate characteristics.

### MODES FOR CARRYING OUT THE INVENTION

The present invention relates to a titanium-containing oxide powder suitable as a negative electrode material for an all-solid-state secondary battery, a negative electrode active material composition using the titanium-containing oxide powder, and an all-solid-state secondary battery.

### [Titanium-Containing Oxide Powder of the Present Invention]

It is a titanium-containing oxide powder whose main component is a titanium-containing oxide represented by Li₄Ti₅O₁₂ or Ti_{1-X/2}Nb₂O_{7-X} (0≤X<2) and the titanium-containing oxide powder contains the titanium-containing oxide particles and a solvate ionic liquid comprising a Li salt and an organic solvent.

[Lithium Titanate Powder Whose Main Component is Li₄Ti₅O₁₂]

The lithium titanate powder of the present invention contains Li₄Ti₅O₁₂ as a main component and can contain a crystalline component and/or an amorphous component other than Li₄Ti₅O₁₂ within a range in which the effects of the present invention can be obtained. The main component as used herein refers to the proportion of the intensity of the Li₄Ti₅O₁₂ main peak being 90% or more of the diffraction peaks measured by X-ray diffraction. In the lithium titanate powder of the present invention, the proportion of the intensity of the Li₄Ti₅O₁₂ main peak is preferably 92% or more and more preferably 95% or more of the diffraction peaks measured by the X-ray diffraction. Components other than Li₄Ti₅O₁₂ refer to the sum of the intensity of the main peak attributed to crystalline components and the highest intensity of the halo pattern attributed to amorphous components. In particular, the lithium titanate powder of the present invention may contain, as the crystalline components, anatase-type titanium dioxide, rutile-type titanium dioxide, and lithium titanate having a different formula, such as Li₂TiO₃ or Li_{0.6}TiO_{3.4}O₈. The lithium titanate powder of the present invention can improve the charge characteristics and charge/discharge capacity of an electricity storage device as the occurrence proportion of crystalline components other than Li₄Ti₅O₁₂, particularly Li_{0.6}Ti_{3.4}O₈, decreases. It is particularly preferred that the sum of the intensity of the main peak of anatase-type titanium dioxide, the intensity of the main peak of rutile-type titanium dioxide, and the intensity corresponding to the main peak of Li₂TiO₃, which is calculated by multiplying the peak intensity corresponding to the (−133) plane of Li₂TiO₃ by 100/80, be 5 or less, where the intensity of the main peak of Li₄Ti₅O₁₂ among the diffraction peaks measured by X-ray diffraction is 100. Here, the main peak of Li₄Ti₅O₁₂ refers to a peak corresponding to the diffraction peak attributed to the (111) plane (2θ=18.33) of Li₄Ti₅O₁₂ in the PDF card 00-049-0207 of ICDD (PDF 2010). The main peak of anatase-type titanium dioxide refers to a peak corresponding to the diffraction peak attributed to the (101) plane (2θ=25.42) in the PDF card 01-070-6826. The main peak of rutile-type titanium dioxide refers to a peak corresponding to the diffraction peak attributed to the (110) plane (2θ=27.44) in the PDF card 01-070-7347. The peak corresponding to the (−133) plane of Li₂TiO₃ refers to a peak corresponding to the diffraction peak attributed to the (−133) plane (2θ=43.58) of Li₂TiO₃ in the PDF card 00-033-0831. The main peak of Li_{0.6}Ti_{3.4}O₈ refers to a peak corresponding to the diffraction peak attributed to the (101) plane (2θ=19.98) in the PDF card 01-070-2732. The term “ICDD” is an abbreviation of International Centre for Diffraction Data, and “PDF” is an abbreviation of the powder diffraction file.

[Niobium-Titanium Composite Oxide Powder Represented by the General Formula Ti_{1-X/2}Nb₂O_{7-X} (0≤X<2)]

The niobium-titanium composite oxide powder of the present invention contains a niobium-titanium composite oxide represented by the general formula Ti_{1-X/2}Nb₂O_{7-X} (0≤X<2). Specific examples of compounds include TiNb₂O₇ or the like that is a niobium-titanium composite oxide capable of absorbing/desorbing Li ions and/or Na ions. The TiNb₂O₇ is excellent in the initial discharge capacity and is preferably contained in the niobium-titanium composite oxide powder. The niobium-titanium composite oxide may partially contain a titanium oxide phase (e.g., rutile-type TiO₂, TiO, etc.) derived from a synthetic raw material. In the case of niobium-titanium composite oxide, the ratio of the molar number of Nb to the molar number of Ti (Nb/Ti ratio) is preferably within a range of 1.5 to 2.5 and further preferably 1.8 to 2.0. Within this range, the electron conductivity of the niobium-titanium composite oxide is improved and the rate characteristics are excellent.

There are no limitations on the crystal system of the niobium-titanium composite oxide of the present invention, but it is generally in a monoclinic system. In the case of a monoclinic form, the aspect ratio tends to be large, but it is preferably within a range of 1.0 to 4.0 from the viewpoint of electrode density.

### <Solvate Ionic Liquid>

The titanium-containing oxide powder of the present invention whose main component is a titanium-containing oxide represented by Li₄Ti₅O₁₂ or Ti_{1-X/2}Nb₂O_{7-X} (0≤X<2) is characterized by containing the titanium-containing oxide particles, which constitutes the titanium-containing oxide powder, and a solvate ionic liquid. The solvate ionic liquid of the present invention, which comprises a Li salt and an organic solvent, inactivates the active sites on the surfaces of the titanium-containing oxide particles and effectively suppresses the reaction with the solid electrolyte. It is sufficient that the solvate ionic liquid is a liquid at −30° C.

### <Li Salt>

A first Li salt contained in the solvate ionic liquid of the present invention is preferably one type of Li salt selected from the group consisting of LiPF₆, LiBF₄, LiN(SO₂F)₂ [LFSI], LiN(SO₂CF₃)₂ [LTFSI], and LiN(SO₂C₂F5)₂, and two or more types may also be combined. Among them, it is preferred to use LTFSI and/or LFSI.

To further improve the charge rate characteristics, the solvate ionic liquid of the present invention preferably contains a second Li salt. The second Li salt is preferably contained as one or more types of Li salts selected from the group consisting of a Li salt having an oxalic acid frame, a Li salt having a phosphoric acid frame, and a Li salt having an S═O group (excluding LTFSI or LFSI). The solvate ionic liquid of the present invention may contain both the first Li salt and the second Li salt.

Preferred examples of the Li salt having an oxalic acid frame, which is contained in the solvate ionic liquid of the present invention, include lithium bis(oxalato)borate (LiBOB), lithium difluoro(oxalato)borate (LiDFOB), lithium tetrafluoro(oxalato)phosphate (LiTFOP), and lithium difluorobis(oxalato)phosphate (LiDFOP), among which LiBOB, LiDFOB, and LiDFOP are preferred.

Preferred examples of the Li salt having a phosphoric acid frame and the Li salt having an S═O group, which are contained in the solvate ionic liquid of the present invention, include lithium difluorophosphate (LPF), lithium fluorophosphate (Li₂PO₃F), lithium fluorosulfate (FSO₃Li), lithium methyl sulfate (LMS), lithium ethyl sulfate (LES), lithium 2,2,2-trifluoroethyl sulfate (LFES), lithium trifluoro((methanesulfonyl)oxy)borate (LiTFMSB), and lithium pentafluoro((methanesulfonyl)oxy)phosphate (LiPFMSP), among which LPF, LMS, LES, FSO₃Li, and LiTFMSB are preferred, and LMS and LES are further preferred.

When the first Li salt and the second Li salt are contained, the molar ratio of the first Li salt and the second Li salt is preferably (first Li salt):(second Li salt)=99.5:0.5 to 80:20 because the charge rate characteristics can be further improved, further preferably (first Li salt):(second Li salt)=99.3:0.7 to 85:15, furthermore preferably (first Li salt):(second Li salt)=99:1 to 90:10, and particularly preferably (first Li salt):(second Li salt)=99:1 to 97:3.

### <Organic Solvent>

Suitable examples of the organic solvent used in the solvate ionic liquid of the present invention include cyclic carbonates, lactones, and chain ether compounds. Examples of the cyclic carbonates include ethylene carbonate (EC), propylene carbonate (PC), vinylene carbonate (VC), and vinyl ethylene carbonate (VEC), and examples of the lactones include gamma butyl lactone (GBL). The chain ether compounds are preferably those having a methoxy group and having a carbon number of 2 or more, more preferably those having 2 or more methoxy groups, and further preferably those having 4 or more carbon atoms, 10 or more hydrogen atoms, and two or more oxygen atoms.

Specific examples of the chain ether compounds include one or more selected from alkylene glycol dimethyl ether and dimethoxyethane. As the alkylene glycol group in the alkylene glycol dimethyl ether, a triethylene glycol group and a tetraethylene glycol group are preferred.

Particularly preferred specific examples of the chain ether compounds include one or more selected from triethylene glycol dimethyl ether (same as triglyme), tetraethylene glycol dimethyl ether (same as tetraglyme TetraG), and dimethoxyethane.

### <Molar Ratio of [Li Salt/Organic Solvent]>

In the solvate ionic liquid of the present invention, the molar ratio of the total Li salts to the organic solvent [total Li salts/organic solvent] is preferably 0.3 or more and 2.5 or less because the organic solvent needs to be completely coordinated with the Li salt. When the molar ratio is 0.3 or more, the organic solvent is not excessive with respect to lithium and the charge rate characteristics do not deteriorate, so this is preferred. When the organic solvent is dimethoxyethane, the molar ratio is preferably 0.4 or more and more preferably 0.5 or more. Additionally or alternatively, the upper limit of the molar ratio is preferably 1.8 or less and more preferably 1.5 or less.

When the organic solvent is alkylene glycol dimethyl ether such as triethylene glycol dimethyl ether or tetraethylene glycol dimethyl ether, the molar ratio is preferably 0.7 or more and more preferably 0.75 or more. Additionally or alternatively, the upper limit of the molar ratio is preferably 2.2 or less and more preferably 2.0 or less.

In the titanium-containing oxide powder of the present invention, the content of the solvate ionic liquid may be 0.05 mass % or more and 30 mass % or less with respect to 100 mass % of the titanium-containing oxide. When the content is 0.05 mass % or more, the active sites on the particle surface of the titanium-containing oxide can be inactivated to appropriately improve the rate characteristics, while when the content is 30 mass % or less, the shape of the powder is maintained even though the solvate ionic liquid is contained. The content is preferably 0.1 mass % or more, more preferably 1 mass % or more, further preferably 3 mass % or more, and particularly preferably 5 mass % or more with respect to 100 mass % of the titanium-containing oxide. Additionally or alternatively, the upper limit of the content is preferably 27 mass % or less and more preferably 25 mass % or less.

### <Specific Surface Area>

The specific surface area of the titanium-containing oxide powder of the present invention refers to an adsorption area per unit mass when nitrogen is used as the adsorption gas. The measurement method will be described in Examples, which will be described later.

In the titanium-containing oxide which is the main component of the titanium-containing oxide powder of the present invention, when the specific surface area is 1 m²/g or more and 10 m²/g or less, the titanium-containing oxide powder having excellent initial discharge capacity and charge rate characteristics can be obtained. The specific surface area is preferably 2 m²/g or more and 9 m²/g or less and more preferably 4 m²/g or more and 8.5 m²/g or less.

### <Containment of Al>

The titanium-containing oxide powder of the present invention may contain Al on the surfaces of the titanium-containing oxide particles, which are the main component of the titanium-containing oxide, because the charge rate characteristics can be further improved. Containing Al means that Al is detected by a known analysis device such as X-ray fluorescence spectrometry (XRF) or inductively coupled plasma atomic emission spectrometry (ICP-AES) for the titanium-containing oxide powder of the present invention. The lower limit of the quantity detectable by the inductively coupled plasma atomic emission spectrometry is usually 0.001 mass %.

### <Content Ratio of Al>

When Al is contained in the surfaces of the titanium-containing oxide particles, the content ratio of Al in the titanium-containing oxide powder determined by X-ray fluorescence analysis (XRF) is 0.01 mass % or more and 5 mass % or less as the content of Al. When the content ratio of Al is within this range, the titanium-containing oxide powder for a negative electrode can be obtained for an all-solid-state secondary battery excellent in the charge rate characteristics. The content ratio of Al is preferably 0.01 mass % or more and 2 mass % or less, more preferably 0.01 mass % or more and 0.8 mass % or less, further preferably 0.01 mass % or more and 0.6 mass % or less, and furthermore preferably 0.1 mass % or more and 0.4 mass % or less. The content ratio represents a proportion of the mass of Al to the mass of the entire titanium-containing oxide powder.

In the titanium-containing oxide powder of the present invention, it is sufficient that Al is present on the surfaces of the titanium-containing oxide particles constituting the titanium-containing oxide powder, and it is preferred that Al be present more on the surfaces of primary particles of the titanium-containing oxide contained in the titanium-containing oxide powder than inside the primary particles. Specifically, the relation represented by the following expression (I) is preferably satisfied, and the relation represented by the following expression (II) is more preferably satisfied:

C1>C2 (I)

C1/C2≥5 (II)

where C1 (atm %) is the atomic concentration of Al at a depth position of 1 nm from the surfaces of primary particles of the titanium-containing oxide, and C2 (atm %) is the atomic concentration of Al at a depth position of 100 nm from the surfaces of primary particles of the titanium-containing oxide. The atomic concentrations are measured by energy dispersive X-ray spectroscopy in cross-sectional analysis of the primary particles of the titanium-containing oxide using a scanning transmission electron microscope.

In the titanium-containing oxide powder, preferably, Al is not detected at a depth position of 100 nm from the surfaces of the primary particles of the titanium-containing oxide measured by energy dispersive X-ray spectroscopy using a scanning transmission electron microscope in cross-sectional analysis of the primary particles of the titanium-containing oxide which is the main component of the titanium-containing oxide powder. It is preferred that Al be fixed on the surfaces of the primary particles in a chemically bonded state. When Al is present in such a state, a dense negative electrode layer having few voids can be obtained, and an all-solid-state secondary battery excellent in the initial discharge capacity and charge rate characteristics can be obtained. Although the lower limit of the quantity detectable by energy dispersive X-ray spectroscopy varies according to the elements to be measured or the state thereof, the lower limit is usually 0.5 atm %. Al may therefore be detected in a range of 0.5 atm % or less at a depth position of about 100 nm.

### <D50>

D50 of the titanium-containing oxide powder of the present invention is an index of the volume median particle diameter. It means a particle diameter at which the cumulative volume frequency calculated based on the volume fraction is 50% in cumulation in ascending order of particle diameter. The cumulative volume frequency is obtained by laser diffraction/scattering particle size distribution measurement. The measuring method will be described in Examples, which will be described later.

From the viewpoint of improving the initial discharge capacity and charge rate characteristics and the density of the negative electrode layer, D50 of the primary particles of the titanium-containing oxide powder according to the present invention is 0.5 μm or more, preferably 0.55 μm or more, and more preferably 0.6 μm or more. Additionally or alternatively, D50 of the primary particles is 5 μm or less, preferably 4.5 μm or less, and more preferably 4 μm or less. The titanium-containing oxide powder may contain primary particles having a primary particle diameter of less than 0.5 μm within a cumulative volume frequency of 10% to 50%, may contain primary particles having a primary particle diameter of less than 0.55 μm within the range of a cumulative volume frequency of 10% to 55%, or may contain primary particles having a primary particle diameter of less than 0.6 μm within the range of a cumulative volume frequency of 10% to 60%. Additionally or alternatively, the titanium-containing oxide powder may contain primary particles having a primary particle diameter of more than 5 μm within the range of a cumulative volume frequency of 50% to 90%, may contain primary particles having a primary particle diameter of more than 4.5 μm within the range of a cumulative volume frequency of 45% to 90%, or may contain primary particles having a primary particle diameter of more than 4 μm within the range of a cumulative volume frequency of 40% to 90%.

[Method of Producing Lithium Titanate Powder of the Present Invention Whose Main Component is Li₄Ti₅O₁₂]

One example of a method of producing the lithium titanate powder of the present invention will now be described separately with a step of preparing raw materials, a calcination step, a surface treatment step, and a step of mixing with the solvate ionic liquid, but the method of producing the lithium titanate powder of the present invention is not limited to this.

### <Step of Preparing Raw Materials>

The raw materials for the lithium titanate powder of to the present invention are composed of a titanium raw material and a lithium raw material. As the titanium raw material, titanium compounds such as anatase-type titanium dioxide and rutile-type titanium dioxide are used. It is preferred that the titanium raw material readily react with the lithium raw material in a short time. From this viewpoint, anatase-type titanium dioxide is preferred. To sufficiently react the raw materials by calcination in a short time, D50 of the titanium raw material is preferably 5 μm or less.

As the lithium raw material, lithium compounds such as lithium hydroxide monohydrate, lithium oxide, lithium hydrogen carbonate, and lithium carbonate are used.

As for the preparation ratio of the titanium raw material and the lithium raw material, the atomic ratio Li/Ti of Li to Ti may be 0.81 or more and preferably 0.83 or more. This is because if the preparation ratio is low, the lithium titanate powder obtained after calcination will promote the generation of a specific impurity phase, which may adversely affect the battery characteristics.

In the case where a mixture composed of the raw materials above is calcined in a short time in the present invention, before the calcination, the mixed powders constituting the mixture is preferably prepared such that D95 in a particle size distribution curve measured with a laser diffraction/scattering particle size distribution analyzer is 5 μm or less. Here, D95 refers to a particle diameter at which the cumulative volume frequency calculated based on the volume fraction is 95% in cumulation in ascending order of particle diameter.

As the method of preparing the mixture, the methods listed below can be used. A first method is a method of preparing raw materials and then milling and mixing the raw materials at the same time. A second method is a method of milling raw materials until the D95 becomes 5 μm or less and then mixing these raw materials or mixing these materials while lightly milling those. A third method is a method of producing powders each composed of nanoparticles by a method such as crystallization of raw materials, classifying the powders as needed, and then mixing these powders or mixing these powders while lightly milling those. Among these methods, the first method in which mixing of the raw materials and milling thereof are performed at the same time is industrially advantageous because this method has a smaller number of steps. A conductive agent may be added at the same time.

In all of the first to third methods, there are no particular limitations on the method of mixing the raw materials, and either wet mixing or dry mixing may be used. For example, Henschel mixers, ultrasonic dispersion apparatuses, homomixers, mortars, ball mills, centrifugal ball mills, planetary ball mills, vibration ball mills, Attritor high-speed ball mills, bead mills, roll mills, etc. can be used.

In the case where the mixture obtained by any of the first to third methods is a mixed powder, it can be fed to the subsequent calcination step without any modification. In the case where the resulting mixture is a mixed slurry of mixed powder, the mixed slurry after dried with a rotary evaporator or the like can be fed to the subsequent calcination step. In the case where the calcination is performed with a rotary kiln furnace, the mixed slurry can be fed as it is into the furnace.

### <Calcination Step>

The resulting mixture is then calcined. From the viewpoint of reducing the proportion of the specific impurity phase, increasing the crystallinity of the lithium titanate, and increasing the crystallite size and the primary particle diameter of the powder, the highest temperature during the calcination is 800° C. or higher and preferably 810° C. or higher. From the viewpoint of increasing the specific surface area of the powder obtained by the calcination and reducing the amount of impurities derived from the furnace tube, the highest temperature during the calcination is 1100° C. or lower, preferably 1000° C. or lower, and more preferably 960° C. or lower. From the above two viewpoints, the retention time at the highest temperature during the calcination is 2 to 60 minutes, preferably 5 to 45 minutes, and more preferably 5 to 35 minutes. When the highest temperature during the calcination is high, it is preferred to select a shorter retention time. In the heating process during the calcination, from the viewpoint of increasing the crystallite size obtained by the calcination, the residence time at 700° C. to 800° C. is preferably shortened, for example, within 15 minutes.

Any calcination method that can be performed under the above conditions can be used. Examples of usable calcination methods include fixed bed calcination furnaces, roller hearth calcination furnaces, mesh belt calcination furnaces, fluidized bed calcination furnaces, and rotary kiln calcination furnaces. In the case where the calcination is efficiently performed in a short time, roller hearth calcination furnaces, mesh belt calcination furnaces, and rotary kiln calcination furnaces are preferred. When a roller hearth calcination furnace or a mesh belt calcination furnace which performs calcination with the mixture accommodated in a sagger is used, a small amount of mixture is preferably accommodated in the sagger to ensure the uniformity of the temperature distribution of the mixture during the calcination and yield the lithium titanate powder with a constant level of quality.

The rotary kiln calcination furnace is a particularly preferred calcination furnace to produce the lithium titanate powder of the present invention because any container which accommodates the mixture is unnecessary, the calcination can be performed while the mixture is continuously being fed, and the calcined product has a uniform thermal history to generate homogeneous lithium titanate powder.

Irrespective of the calcination furnace, the calcination can be performed in any atmosphere in which desorbed water and carbon dioxide gas can be removed. Although the atmosphere is usually an air atmosphere using compressed air, an oxygen, nitrogen, or hydrogen atmosphere may also be used.

The lithium titanate powder after the calcination is slightly agglomerated, but does not need to be milled to break particles. For this reason, after the calcination, disintegration to loosen the agglomerates or classification may be performed as needed. If only disintegration to loosen the agglomerates is performed without milling, the lithium titanate powder after the calcination maintains high crystallinity even after the disintegration.

The lithium titanate powder before the surface treatment prepared through the steps above (Such lithium titanate powder may be referred to as lithium titanate base powder, hereinafter. Likewise, the lithium titanate particles constituting the lithium titanate base powder may be referred to as lithium titanate base particles, hereinafter) is mixed with a treatment agent, and the mixture is preferably subjected to a heat treatment.

### <Surface Treatment Step>

The lithium titanate powder of the present invention may be one containing Al, and when containing Al, the lithium titanate powder can impart more excellent charge rate characteristics when applied as a negative electrode material for an all-solid-state secondary battery. In the calcination step, a compound containing Al (which may be referred to as a treatment agent, hereinafter) can be added to produce the lithium titanate powder of the present invention, but more preferably, the lithium titanate powder of the present invention can be produced by a surface treatment step or the like as below.

Examples of the compound (treatment agent) containing Al include, but are not particularly limited to, oxides, hydroxides, sulfate compounds, nitrate compounds, fluorides, and organic compounds of aluminum and metal salt compounds containing aluminum. Specific examples of the compound containing Al include aluminum acetate, aluminum fluoride, and aluminum sulfate.

The compound (treatment agent) containing Al may be added in any amount as long as the content of Al in the lithium titanate powder falls within the above range, but may be added in a proportion of 0.1 mass % or more of the lithium titanate base powder. The compound may be added in a proportion of 12 mass % or less, preferably 10 mass % or less, and more preferably 8 mass % or less of the lithium titanate base powder.

The mixing method for the lithium titanate base powder and the compound containing Al is not particularly limited, and either wet mixing or dry mixing can be used, but it is preferred to uniformly disperse the compound containing Al on the surfaces of the lithium titanate base particles, and in this respect the wet mixing is preferred.

In the dry mixing, for example, paint mixers, Henschel mixers, ultrasonic dispersion apparatuses, homomixers, mortars, ball mills, centrifugal ball mills, planetary ball mills, vibration ball mills, Attritor high-speed ball mills, bead mills, roll mills, etc. can be used.

In the wet mixing, the treatment agent and the lithium titanate base powder are put into water or an alcohol solvent and mixed in a slurry state. Preferred examples of the alcohol solvent include those having a boiling point of 100° C. or lower, such as methanol, ethanol, and isopropyl alcohol, because these solvents are easy to remove. An aqueous solvent is industrially preferred because it is easy to recover and discard.

Although the amount of solvent is non-problematic if the treatment agent and the lithium titanate base particles are sufficiently wet, it is sufficient that the treatment agent and the lithium titanate base particles are uniformly dispersed in the solvent. For this purpose, the solvent is preferably used in an amount such that the amount of the treatment agent dissolved in the solvent is 50% or more of the total amount of the treatment agent added to the solvent. The amount of the treatment agent dissolved in the solvent increases at higher temperature. Accordingly, the mixing of the lithium titanate base powder with the treatment agent in the solvent is preferably performed under heating. In addition, the amount of solvent can be reduced by the heating. For this reason, the mixing method under heating is industrially suitable. The temperature during the mixing is preferably 40° C. to 100° C. and more preferably 60° C. to 100° C.

In the case of wet mixing, although depending on the heat treatment method, the solvent is preferably removed before the heat treatment, which is performed after the mixing step. The solvent is preferably removed by evaporating the solvent to dryness. Examples of the method of evaporating the solvent into dryness include a method of evaporating the solvent by heating a slurry while stirring the slurry with a stirring blade, a method using a drying apparatus, such as a conical dryer, which enables drying an object while stirring the object, and a method using a spray dryer. If the heat treatment is performed using a rotary kiln furnace, mixed raw materials in the form of slurry can be fed into the furnace.

It is preferred to perform heat treatment after mixing the lithium titanate base powder and the treatment agent. The temperature for the heat treatment is preferably a temperature at which Al diffuses to at least surface regions of the lithium titanate base particles without causing a significant reduction in the specific surface areas of the lithium titanate base particles, which is caused as a result of sintering of the lithium titanate base particles. The upper limit of the temperature for the heat treatment may be 700° C. or lower and preferably 600° C. or lower. The lower limit of the temperature for the heat treatment may be 300° C. or higher and preferably 400° C. or higher. The time for the heat treatment may be 0.1 to 8 hours and preferably 0.5 to 5 hours. The temperature and the time for Al to diffuse to at least the surface regions of the lithium titanate base particles may be set as appropriate because the reactivity varies according to the compound containing Al.

Any heating method can be used in the heat treatment. Examples of usable heat treatment furnaces include fixed bed calcination furnaces, roller hearth calcination furnaces, mesh belt calcination furnaces, fluidized bed calcination furnaces, and rotary kiln calcination furnaces. The atmosphere during the heat treatment may be either an air atmosphere or an inert atmosphere such as a nitrogen atmosphere.

The lithium titanate powder thus obtained after the heat treatment has agglomerated to a small extent, but does not need to be milled to break particles. For this reason, after the heat treatment, disintegration to loosen the agglomerates or classification may be performed as needed.

The lithium titanate powder of the present invention may be formed into a powder containing secondary particles, which are agglomerates of primary particles, by mixing the lithium titanate powder with the treatment agent in the surface treatment step, and then performing granulation and a heat treatment on the mixture. Any granulation method which enables formation of secondary particles can be used. Preferred is a spray dryer because a large amount of powder can be treated.

<Step of Mixing with Solvate Ionic Liquid>

The method of mixing with the solvate ionic liquid is not particularly limited, and preferred examples of the method include a method of adding a specific proportion of the solvate ionic liquid to the lithium titanate powder and mixing them in a planetary mill, etc. and a method of adding a specific proportion of the solvate ionic liquid to a slurry containing the lithium titanate powder and a dispersion medium, mixing them, and then distilling away the dispersion medium to combine the solvate ionic liquid and the lithium titanate powder.

Heat treatment may be performed after mixing the lithium titanate powder and the solvate ionic liquid. The upper limit of the heat treatment temperature may be 300° C. or lower and preferably 250° C. or lower. The lower limit of the heat treatment temperature may be 80° C. or higher and preferably 100° C. or higher. The heat treatment time may be 0.1 to 8 hours and preferably 0.5 to 5 hours. The temperature and time may be appropriately set according to the type of the solvate ionic liquid.

The lithium titanate mixed with the solvate ionic liquid obtained in the present invention has solidity that can maintain its own shape.

[Method of Producing Niobium-Titanium Composite Oxide Powder of the Present Invention Represented by the General Formula Ti_{1-X/2}Nb₂O_{7-X} (0≤X<2)]

One example of a method of producing the niobium-titanium composite oxide powder of the present invention will now be described separately with a step of preparing raw materials, a calcination step, a surface treatment step, and a step of mixing with the solvate ionic liquid, but the method of producing the niobium-titanium composite oxide powder of the present invention is not limited to this.

### <Step of Preparing Raw Materials>

First, the starting materials are mixed. Particularly in the case of a niobium-titanium composite oxide, oxides or salts containing Ti and Nb are used as the starting materials. When other additive elements for the niobium-titanium composite oxide are contained, the salts used as the starting materials are preferably those that decompose at a relatively low melting point to generate oxides, such as a hydroxide salt, carbonate, and nitrate. To ensure sufficient progression of the element diffusion in the calcination step, which will be described below, it is preferred to use powders having an average particle diameter of 2 μm or less and preferably 0.5 μm or less as the starting materials.

There are no particular limitations on the method of mixing the raw materials, and either wet mixing or dry mixing may be used. For example, Henschel mixers, ultrasonic dispersion apparatuses, homomixers, mortars, ball mills, centrifugal ball mills, planetary ball mills, vibration ball mills, Attritor high-speed ball mills, bead mills, roll mills, etc. can be used.

### <Calcination Step>

The mixture obtained above is then calcined. Calcination is carried out within a temperature range of 500° C. to 1200° C. and more preferably within a range of 700° C. to 1000° C. General-purpose equipment can be used by carrying out the calcination at a temperature of 1000° C. or lower. When the mixture is calcined in a short time, before the calcination, the mixed powders constituting the mixture is preferably prepared such that D95 in a particle size distribution curve measured with a laser diffraction/scattering particle size distribution analyzer is 5 μm or less. Here, D95 refers to a particle diameter at which the cumulative volume frequency calculated based on the volume fraction is 95% in cumulation in ascending order of particle diameter.

Any calcination method that can be performed under the above conditions can be used. Examples of usable calcination methods include fixed bed calcination furnaces, roller hearth calcination furnaces, mesh belt calcination furnaces, fluidized bed calcination furnaces, and rotary kiln calcination furnaces. In the case where the calcination is efficiently performed in a short time, roller hearth calcination furnaces, mesh belt calcination furnaces, and rotary kiln calcination furnaces are preferred. In particular, the rotary kiln calcination furnace is an especially preferred calcination furnace to produce the niobium-titanium composite oxide powder of the present invention because any container which accommodates the mixture is unnecessary, the calcination can be performed while the mixture is continuously being fed, and the calcined product has a uniform thermal history to generate homogeneous lithium titanate powder.

### <Surface Treatment Step>

The niobium-titanium composite oxide powder of the present invention can be produced in the same manner as the surface treatment step of the aforementioned method of producing the lithium titanate powder whose main component is Li₄Ti₅O₁₂.

<Step of Mixing with Solvate Ionic Liquid>

The niobium-titanium composite oxide powder of the present invention can be produced in the same manner as the step of mixing with the solvate ionic liquid in the aforementioned method of producing the lithium titanate powder whose main component is Li₄Ti₅O₁₂.

The niobium-titanium composite oxide powder mixed with the solvate ionic liquid obtained in the present invention has solidity that can maintain its own shape.

### <Periodic Table>

Periodic Table in the present invention refers to the periodic table of long-period elements based on the regulations of the IUPAC (International Union of Pure and Applied Chemistry).

### [Inorganic Solid Electrolyte]

The inorganic solid electrolyte is a solid electrolyte that is inorganic, and the solid electrolyte is an electrolyte that is solid and can move ions inside it. Since inorganic solid electrolytes are solid in the steady state, they are usually not dissociated or released into cations and anions. The inorganic solid electrolyte is not particularly limited as long as it has conductivity for metal ions belonging to Group 1 of Periodic Table, and generally has almost no electron conductivity.

In the present invention, the inorganic solid electrolyte has the conductivity for metal ions belonging to Group 1 of Periodic Table. Representative examples of the inorganic solid electrolyte include (A) a sulfide inorganic solid electrolyte and (B) an oxide inorganic solid electrolyte. In the present invention, the sulfide inorganic solid electrolyte is preferably used because it has high ion conductivity and can form a dense compact having few grain boundaries only by applying pressure at room temperature.

### (A) Sulfide Inorganic Solid Electrolyte

The sulfide inorganic solid electrolyte preferably contains sulfur atoms (S) and has conductivity for metal ions belonging to Group 1 of Periodic Table and electron insulation properties. The sulfide inorganic solid electrolyte can be produced by reacting a metal sulfide belonging to Group 1 of Periodic Table with at least one sulfide represented by the following general formula (III). Two or more sulfides represented by the following general formula (III) may also be used in combination.

MₓS_{y} (III)

(M represents any one of P, Si, Ge, B, Al, Ga, or Sb, and x and y each represent a number that gives a stoichiometric ratio depending on the type of M.)

The metal sulfide belonging to Group 1 of Periodic Table represents any one of lithium sulfide, sodium sulfide, or potassium sulfide. Lithium sulfide or sodium sulfide is more preferred, and lithium sulfide is further preferred.

The sulfide represented by the general formula (III) is preferably any one of P₂S₅, SiS₂, GeS₂, B₂S₃, Al₂S₃, Ga₂S₃, or Sb₂S₅, and P₂S₅ is particularly preferred.

The composition ratio of elements in the sulfide inorganic solid electrolyte produced as described above can be controlled by adjusting the compounding amounts of the metal sulfide belonging to Group 1 of Periodic Table, the sulfide represented by the general formula (III), and elemental sulfur.

The sulfide inorganic solid electrolyte of the present invention may be amorphous glass, crystallized glass, or a crystalline material.

As the sulfide inorganic solid electrolyte, the following combinations are specifically suitable, but are not particularly limited.

Li₂S—P₂S₅, Li₂S—P₂S₅—Al₂S₃, Li₂S—GeS₂, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, and Li₁₀GeP₂Si₂.

Among the above combinations, LPS glass and LPS glass ceramics produced by combining Li₂S—P₂S₅ are preferred.

The mixing proportion of the metal sulfide belonging to Group 1 of Periodic Table and the sulfide represented by the general formula (III) is not particularly limited as long as the reaction product can be used as a solid electrolyte, but the proportion is preferably 50:50 to 90:10 (molar ratio). When the molar ratio of the metal sulfide is 50 or more and 90 or less, the ion conductivity can be sufficiently enhanced. The mixing ratio (molar ratio) is more preferably 60:40 to 80:20 and further preferably 70:30 to 80:20.

To enhance the ion conductivity, the sulfide inorganic solid electrolyte may contain at least one lithium halide selected from LiI, LiBr, LiCl, and LiF, or a lithium oxide, or a lithium salt such as lithium phosphate in addition to the metal sulfide belonging to Group 1 of Periodic Table and the sulfide represented by the general formula (III). The mixing proportion of the sulfide inorganic solid electrolyte and such a Li salt is preferably 60:40 to 95:5 (molar ratio) and more preferably 80:20 to 95:5.

In addition to the above, suitable examples of the sulfide inorganic solid electrolyte include argyrodite-type solid electrolytes such as Li₆PS₅Cl and Li₆PS₅Br.

Examples of the method for producing the sulfide inorganic solid electrolyte include, but are not particularly limited to, a solid phase method, a sol-gel method, a mechanical milling method, a solution method, and a melt quenching method.

### (B) Oxide Inorganic Solid Electrolyte

The oxide inorganic solid electrolyte preferably contains oxygen atoms and has conductivity for metal ions belonging to Group 1 of Periodic Table and electron insulation properties.

Preferred examples of the oxide inorganic solid electrolyte include Li_{3.5}Zn_{0.25}GeO₄ having a LISICON (lithium superionic conductor) type crystal structure, La_{0.55}Li_{0.35}TiO₃ having a perovskite type crystal structure, LiTi₂P₃O₁₂ having a NASICON (Na superionic conductor) type crystal structure, Li₇La₃Zr₂O₁₂ (LLZ) having a garnet type crystal structure, lithium phosphate (Li₃PO₄), LiPON in which part of oxygen of lithium phosphate is substituted with nitrogen, Li₃BO₃—Li₂SO₄, Li₂O—B₂O₃—P₂O₅, Li₂O—SiO₂, and Li₆BaLa₂Ta₂O₁₂.

The volume average particle diameter of the inorganic solid electrolyte is not particularly limited, but may be 0.01 μm or more and preferably 0.1 μm or more. The upper limit may be 100 μm or less and preferably 50 μm or less. The volume average particle diameter of the inorganic solid electrolyte can be measured using a laser diffraction/scattering particle size distribution analyzer.

### <Negative Electrode Active Material Composition>

The amount of mixing the inorganic solid electrolyte is not particularly limited, but may be 1 mass % or more, preferably 3 mass % or more, more preferably 5 mass % or more, and further preferably 7 mass % or more in the negative electrode active material composition. The higher the amount of mixing the inorganic solid electrolyte, the easier it is to obtain contact between the titanium-containing oxide powder and the solid electrolyte, which is preferred. If the amount of mixing the inorganic solid electrolyte is unduly large, the battery capacity of the all-solid-state secondary battery will be small, so the amount of mixing may be 70 mass % or less and preferably 50 mass % or less. Usually, the amount of mixing the inorganic solid electrolyte is preferably as small as possible in order to increase the battery capacity of the all-solid-state secondary battery, but if the amount of mixing is small, it will be difficult to make contact between the lithium titanate powder and the solid electrolyte. By using the titanium-containing oxide powder used in the negative electrode active material composition of the present invention, it is possible to obtain satisfactory contact between the titanium-containing oxide powder and the solid electrolyte even when the amount of mixing the inorganic solid electrolyte is small.

### [Other Inclusions]

The negative electrode active material composition of the present invention may contain a conductive agent and a binder in addition to the titanium-containing oxide powder and the inorganic solid electrolyte.

The conductive agent for the negative electrode can be any electron conductive material which does not chemically change. Examples thereof include graphites such as natural graphite (flake graphite, etc.) and artificial graphite; carbon blacks such as acetylene black, Ketjen black, channel black, furnace black, lamp black, and thermal black; and carbon nanotubes such as single-walled carbon nanotubes, multi-walled carbon nanotubes (multi-layer of cylindrical graphite layers concentrically disposed) (non-fishbone-like), cup stacked-type carbon nanotubes (fishbone-like)), node-type carbon nanofibers (non-fishbone-like structure), and platelet-type carbon nanofibers (stacked card-like). Graphites, carbon blacks, and carbon nanotubes may be appropriately mixed and used. Although not particularly limited, carbon blacks have a specific surface area of preferably 30 to 3000 m²/g and more preferably 50 to 2000 m²/g. Graphites have a specific surface area of preferably 30 to 600 m²/g and more preferably 50 to 500 m²/g. Carbon nanotubes have an aspect ratio of 2 to 150, preferably 2 to 100, and more preferably 2 to 50.

While the amount of conductive agent to be added varies according to the specific surface area of the active material or the types and combination of conductive agents and therefore should be optimized, the content in the negative electrode active material composition may be 0.1 to 10 mass % and preferably 0.5 to 5 mass %. When the amount of conductive agent to be added falls within a range of 0.1 to 10 mass %, the active material ratio is made sufficient thereby to further enhance the conductivity of the negative electrode layer while allowing the initial discharge capacity of the electricity storage device per unit mass and unit volume of the negative electrode layer to be sufficient.

Examples of the binder for the negative electrode include poly(tetrafluoroethylene) (PTFE), poly(vinylidene fluoride) (PVDF), poly(vinylpyrrolidone) (PVP), copolymer of styrene and butadiene (SBR), copolymer of acrylonitrile and butadiene (NBR), and carboxymethyl cellulose (CMC). Although not particularly limited, poly(vinylidene fluoride) preferably has a molecular weight of 20000 to 100000. From the viewpoint of further enhancing the binding properties of the negative electrode layer, the molecular weight is preferably 25000 or more, more preferably 30000 or more, and further preferably 50000 or more. To further enhance the conductivity without obstructing the contact between the active material and the conductive agent, the molecular weight is preferably 500000 or less. In particular, when the active material has a specific surface area of 10 m²/g or more, the molecular weight is preferably 100000 or more.

While the amount of binder to be added varies according to the specific surface area of the active material or the types and combination of conductive agents and therefore should be optimized, the content of the binder in the negative electrode active material composition may be 0.2 to 15 mass %. To enhance the binding properties and ensure the strength of the negative electrode layer, the content is preferably 0.5 mass % or more, more preferably 1 mass % or more, and further preferably 2 mass % or more. To prevent a reduction in proportion of the active material and a reduction in the initial discharge capacity of the energy storage device per unit mass and unit volume of the negative electrode layer, the content is preferably 10 mass % or less and more preferably 5 mass % or less.

### [Method of Preparing Negative Electrode Active Material Composition]

Examples of the method of preparing the negative electrode active material composition of the present invention include, but are not particularly limited to, a method of adding a specific proportion of the inorganic solid electrolyte powder to the titanium-containing oxide powder and mixing them with a mixer, a stirrer, a disperser, or the like and a method of adding the titanium-containing oxide powder to a slurry containing a solid electrolyte.

The negative electrode active material composition of the present invention can be used for the negative electrodes of all-solid-state secondary batteries. In this case, it is preferred to perform pressure molding of the negative electrode active material composition of the present invention to form a pressure-molded compact. The conditions for pressure molding are not particularly limited, but the molding temperature may be 15° C. to 200° C. and preferably 25° C. to 150° C., and the molding pressure may be 180 MPa to 1080 MPa and preferably 300 MPa to 800 MPa. The negative electrode active material composition of the present invention can form a dense molded compact having few voids, and therefore can form a dense negative electrode layer having few voids. The compact obtained using the negative electrode active material composition of the present invention has a filling rate of 72.5% to 100% and preferably 73.5% to 100%.

### [All-Solid-State Secondary Battery]

The all-solid-state secondary battery of the present invention is composed of a positive electrode, a negative electrode, and a solid electrolyte layer positioned between the positive electrode and the negative electrode. The negative electrode active material composition of the present invention, which includes a titanium-containing oxide powder whose main component is a titanium-containing oxide represented by Li₄Ti₅O₁₂ or Ti_{1-x/2}Nb₂O₇₋ₓ (x=0 to 2) and an inorganic solid electrolyte having conductivity for metal ions belonging to Group 1 of Periodic Table, is used for the negative electrode layer. The method of preparing the negative electrode layer is not particularly limited, and preferred examples of the method include a method of pressure-molding the negative electrode active material composition and a method of adding the negative electrode active material composition to a solvent to form a slurry, then applying the negative electrode active material composition to a current collector, and drying and pressure-molding it.

Examples of the negative electrode current collector include aluminum, stainless steel, nickel, copper, titanium, calcined carbon, and those whose surfaces are coated with carbon, nickel, titanium, or silver. Additionally or alternatively, the surfaces of these materials may be oxidized, or may be subjected to a surface treatment to form depressions and projections on the surface of the negative electrode current collector. Examples of forms of the negative electrode current collector include formed bodies of sheets, nets, foils, films, punched materials, lath bodies, porous bodies, foamed bodies, fiber groups, and nonwoven fabrics. The negative electrode current collector is preferably formed of porous aluminum. The porous aluminum has a porosity of 80% or more and 95% or less and preferably 85% or more and 90% or less.

Provided that a negative electrode layer containing the negative electrode active material composition of the present invention is included, constituent members such as a positive electrode layer and a solid electrolyte layer can be used without particular limitations.

As a positive electrode active material used as the positive electrode layer for an all-solid-state secondary battery, for example, a composite metal oxide with lithium that contains one or more selected from the group consisting of cobalt, manganese, and nickel is used. One of these positive electrode active materials may be used alone or two or more may also be used in combination.

Preferred examples of such lithium composite metal oxides include one or more of, more preferably two or more of, LiCoO₂, LiCo₁₋ₓMₓO₂ (where M is one or more elements selected from Sn, Mg, Fe, Ti, Al, Zr, Cr, V, Ga, Zn, and Cu, 0.001≤x≤0.05), LiMn₂O₄, LiNiO₂, LiCo₁₋ₓNiₓO₂ (0.01<x<1), LiCo_{1/3}Ni_{1/3}Mn_{1/3}O₂, LiNi_{0.5}Mn_{0.3}Co_{0.2}O₂, LiNi_{0.8}Mn_{0.1}Co_{0.1}O₂, LiNi_{0.8}Co_{0.15}Al_{0.05}O₂, a solid solution of Li₂MnO₃ and LiMO₂ (M is a transition metal such as Co, Ni, Mn, or Fe), and LiNi_{1/2}Mn_{3/2}O₄. Combinations may also be used, such as LiCoO₂ and LiMn₂O₄, LiCoO₂ and LiNiO₂, and LiMn₂O₄ and LiNiO₂.

A lithium-containing olivine-type phosphate can also be used as the positive electrode active material. Lithium-containing olivine-type phosphate that contains one or more selected from iron, cobalt, nickel, and manganese is particularly preferred. Specific examples thereof include LiFePO₄, LiCoPO₄, LiNiPO₄, and LiMnPO₄.

Part of such a lithium-containing olivine-type phosphate may be substituted with another element, and part of iron, cobalt, nickel, or manganese may be substituted with one or more elements selected from the group consisting of Co, Mn, Ni, Mg, Al, B, Ti, V, Nb, Cu, Zn, Mo, Ca, Sr, W, and Zr, or can be coated with a compound or carbon material that contains such other elements. Among these, LiFePO₄ or LiMnPO₄ is preferred.

The lithium-containing olivine-type phosphate can be used, for example, by being mixed with the positive electrode active material.

There are no particular limitations on the conductive agent for the positive electrode as long as it is an electronically conductive material that does not cause chemical changes. Examples thereof include graphites such as natural graphite (flake graphite, etc.) and artificial graphite and carbon blacks such as acetylene black, Ketjen black, channel black, furnace black, lamp black, and thermal black. Graphite and carbon black may be mixed and used as appropriate. The amount of the conductive agent added to the positive electrode active material composition is preferably 1 to 10 mass % and particularly preferably 2 to 5 mass %.

The positive electrode active material composition contains at least the positive electrode active material and the solid electrolyte, and if necessary, may contain a conductive agent such as acetylene black or carbon black, a binder such as polytetrafluoroethylene (PTFE), polyvinylidene fluoride (PVDF), a copolymer of styrene and butadiene (SBR), a copolymer of acrylonitrile and butadiene (NBR), carboxymethyl cellulose (CMC), ethylene propylene diene terpolymer, etc. The method of preparing the positive electrode is not particularly limited, and preferred examples of the method include a method of pressure-molding the powder of the positive electrode active material composition and a method of adding the powder of the positive electrode active material composition to a solvent to form a slurry, then applying the positive electrode active material composition to an aluminum foil or a stainless steel lath plate as a current collector, and drying and pressure-molding it.

The surface of the positive electrode active material may be surface-coated with another metal oxide. Examples of surface coating agents include metal oxides and the like that contain Ti, Nb, Ta, W, Zr, Al, Si, or Li. Specific examples include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

The solid electrolyte layer is positioned between the positive electrode and the negative electrode, and the thickness of the solid electrolyte layer may be, but is not particularly limited to, 1 to 100 μm. Usable constituent material of the solid electrolyte layer may be the sulfide inorganic solid electrolyte or the oxide inorganic solid electrolyte, and may be different from the solid electrolyte used for the electrodes. The solid electrolyte layer may contain a binder such as butadiene rubber or butyl rubber.

There are no particular limitations on the structure of the all-solid-state secondary battery, and coin-shaped batteries, cylindrical batteries, rectangular batteries, laminate batteries, etc. can be applied.

### EXAMPLES

### (Lithium Titanate)

The present invention will now be more specifically described by way of Examples and Comparative Examples, but the present invention is not limited to Examples below, and encompasses a variety of combinations which can be easily analogized from the gist of the present invention.

### Production Example 1

### <Step of Preparing Raw Materials>

Li₂CO₃ (average particle diameter: 4.6 μm) and anatase-type TiO₂ (specific surface area: 10 m²/g) were weighed such that the atomic ratio of Li to Ti (Li/Ti) was 0.83. A raw material powder was thereby prepared. Deionized water was added to and stirred with the raw material powder to give a raw material mixed slurry having a solid content of 41 mass %. Using a bead mill (made by Willy A. Bachofen AG, type: DYNO-MILL KD-20BC, material for the agitator: polyurethane, material for the vessel inner surface: zirconia) including a vessel 80 vol % filled with zirconia beads (outer diameter: 0.65 mm), this raw material mixed slurry was processed at an agitator circumferential speed of 13 m/s and a slurry feed rate of 55 kg/hr under control such that the vessel internal pressure was 0.02 to 0.03 MPa and the raw material powder was wet mixed and milled.

### <Calcination Step>

Using a rotary kiln calcination furnace (length of the furnace core tube: 4 m, diameter of the furnace core tube: 30 cm, external heating type) provided with an anti-adhesion mechanism, the resulting mixed slurry was introduced into the furnace core tube from the raw material feed zone of the calcination furnace, and was dried and calcined in a nitrogen atmosphere. In this operation, the tilt angle of the furnace core tube to the horizontal direction was 2.5 degrees, the rotational speed of the furnace core tube was 20 rpm, and the flow rate of nitrogen introduced from the calcined product recovery zone into the furnace core tube was 20 L/min. The heating temperature of the furnace core tube was 600° C. in the raw material feed zone, 840° C. in the central zone, and 840° C. in the calcined product recovery zone. The retention time of the calcined product at 840° C. was 30 minutes.

### <Post-Treatment Step>

The calcined product recovered from the calcined product recovery zone of the furnace core tube was disintegrated at a screen opening of 0.5 mm, the number of rotations of 8,000 rpm, and a powder feed rate of 25 kg/hr using a hammer mill (made by DALTON CORPORATION, AIIW-5).

### <Granulation Step>

Deionized water was added to and stirred with the calcined powder subjected to disintegration to give a slurry having a solid content of 30 mass %. This mixed slurry was sprayed and dried using a spray dryer (L-8i manufactured by OHKAWARA KAKOHKI CO., LTD.) at an atomizer rotation speed of 25000 rpm and a drying temperature of 250° C. and granulated. Then, the powder passing through the sieve was placed in an alumina sagger and subjected to a heat treatment at 500° C. for one hour in a mesh belt conveying-type continuous furnace having an outlet provided with a recovery box in which the temperature was 25° C. and the dew point was managed at −15° C. or lower. The powder after the heat treatment was cooled and sieved (screen opening: 53 μm) inside the recovery box, the powder passing through the sieve was collected and sealed in an aluminum laminated bag, and then the bag was extracted from the recovery box. The lithium titanate powder was thus produced.

### <Preparation of Solvate Ionic Liquid>

A solvate ionic liquid (LTFSI-TetraG) was obtained by mixing 1 mol of LiN(SO₂CF₃)₂ (LTFSI) with 1 mol of tetraglyme (TetraG) and stirring them well.

### <Mixing Step>

Lithium titanate powder surface-treated with the solvate ionic liquid was prepared by mixing 25 mass % of the solvate ionic liquid prepared above to 100 mass % of the synthesized lithium titanate powder and stirring them well.

### Production Examples 1 to 12

Production Example 1 and other Production Examples were conducted as listed in Tables 1 and 2 as in Production Example 1. In Production Example 4, heat treatment was performed after surface treatment with the solvate ionic liquid, and aluminum sulfate hexadecahydrate (Al₂(SO₄)₃·16H₂O) as a treatment agent was added in an amount of 1.6 mass % to the disintegrated calcined powder during preparation of the mixed slurry in the granulation step in Production Example 4.

In Production Example 7, the treatment with the solvate ionic liquid was not performed, and in Production Examples 8 to 12, two types of Li salts were used when obtaining the solvate ionic liquid, and the amounts used (molar ratio) were as listed in Table 2.

### [Measurement of Al Content Ratio]

The content ratio of Al contained in the lithium titanate powder of Production Example 4 was measured as follows.

### <X-Ray Fluorescence Analysis (XRF): Identification of Al>

Using an X-ray fluorescence analyzer (manufactured by SII Technology Co., Ltd., trade name “SPS5100”), Al contained in the lithium titanate powder according to each of Examples and Comparative Examples was subjected to quantitative analysis.

### [Measurement of Powder Physical Properties]

A variety of physical properties of the lithium titanate powder used in each of Production Examples were measured as follows.

### <Measurement of Specific Surface Area>

The specific surface area (m²/g) of the lithium titanate powder used in each of Production Examples was measured using an automatic BET specific surface area analyzer (made by Mountech Co., Ltd., trade name “Macsorb HM model-1208”), and nitrogen gas was used as the absorption gas. Specifically, 0.5 g of sample powder to be measured was weighed, placed into a φ12 standard cell (HM1201-031), degassed at 100° C. under vacuum for 0.5 hours, and then measured by a BET single-point method.

### <Calculation of D50 of Primary Particles: Wet Laser Diffraction Scattering Method>

The D50 of the lithium titanate powder used in each of Production Examples was calculated from a particle size distribution curve measured using a laser diffraction/scattering particle size distribution analyzer (manufactured by NIKKISO CO., LTD., Microtrac MT3300EXII). Specifically, 50 mg of sample was put into a container containing 50 ml of deionized water as a measurement solvent, the container was shaken by hand until the powder was visually confirmed to be evenly dispersed in the measurement solvent, and the container was placed in a measurement cell for measurement. The disintegration treatment was performed by applying ultrasonic waves (30 W, 3 s) with an ultrasonic device in the apparatus. The measurement solvent was further added until the transmittance of the slurry fell within an appropriate range (the range indicated by the green bar of the apparatus), and the particle size distribution was measured. The D50 of the mixed powder after disintegration was calculated from the obtained particle size distribution curve.

TABLE 1

| | | | Production | Production | Production | Production | Production | Production | Production |
|---|---|---|---|---|---|---|---|---|---|
| | | | Example 1 | Example 2 | Example 3 | Example 4 | Example 5 | Example 6 | Example 7 |
| Preparation of | Lithium raw | Type | Li₂CO₃ | Li₂CO₃ | Li₂CO₃ | Li₂CO₃ | Li₂CO₃ | Li₂CO₃ | Li₂CO₃ |
| raw materials | material | Average particle | 4.6 | 4.6 | 4.6 | 4.6 | 4.6 | 4.6 | 4.6 |
| | | diameter [μm] | | | | | | | |
| | Titanium raw | Type | Anatase | Anatase | Anatase | Anatase | Anatase | Anatase | Anatase |
| | material | | TiO₂ | TiO₂ | TiO₂ | TiO₂ | TiO₂ | TiO₂ | TiO₂ |
| | | Specific surface | 10 | 10 | 10 | 10 | 10 | 10 | 10 |
| | | area [m2/g] | | | | | | | |
| | Mixing | | Wet bead | Wet bead | Wet bead | Wet bead | Wet bead | Wet bead | Wet bead |
| | | | mill | mill | mill | mill | mill | mill | mill |
| | Form | | Slurry | Slurry | Slurry | Slurry | Slurry | Slurry | Slurry |
| Calcination | Calcination furnace | | Rotary kiln calcination furnace | | | | | | |
| | Highest temperature [° C.] | | 840 | 840 | 840 | 840 | 840 | 840 | 840 |
| | Retention time [min] | | 30 | 30 | 30 | 30 | 30 | 30 | 30 |
| Disintegration | Hammer mill disintegration | | Performed | Performed | Performed | Performed | Performed | Performed | Performed |
| Surface | Treatment | Type | — | — | — | Al₂(SO₄)₃, | — | — | — |
| treatment | agent 1 | | | | | 16H₂O | | | |
| | | Amount added | — | — | — | 1.6 | — | — | — |
| | | [mass %] | | | | | | | |
| | Heat | Temperature [° C.] | — | — | — | 500 | — | — | — |
| | treatment | Time [h] | — | — | — | 1 | — | — | — |
| | Treatment | Li salt | LTFSI | LTFSI | LTFSI | LTFSI | LFSI | LTFSI | — |
| | agent 2 | Solvent | TetraG | TetraG | TetraG | TetraG | TetraG | GBL | — |
| | | Molar ratio of | 50:50 | 50:50 | 50:50 | 50:50 | 50:50 | 50:50 | — |
| | | Li salt:solvent | | | | | | | |
| | | Amount added | 25 | 10 | 5 | 25 | 25 | 25 | — |
| | | [mass %] | | | | | | | |

TABLE 2

| | | | Production | Production | Production | Production | Production |
|---|---|---|---|---|---|---|---|
| | | | example 8 | example 9 | example 10 | example 11 | example 12 |
| Preparation of | Lithium raw | Type | Li₂CO₃ | Li₂CO₃ | Li₂CO₃ | Li₂CO₃ | Li₂CO₃ |
| raw materials | material | Average particle | 4.6 | 4.6 | 4.6 | 4.6 | 4.6 |
| | | diameter [μm] | | | | | |
| | Titanium raw | Type | Anatase | Anatase | Anatase | Anatase | Anatase |
| | material | | TiO₂ | TiO₂ | TiO₂ | TiO₂ | TiO₂ |
| | | Specific surface | 10 | 10 | 10 | 10 | 10 |
| | | area [m2/g] | | | | | |
| | Mixing | | Wet bead | Wet bead | Wet bead | Wet bead | Wet bead |
| | | | mil | mill | mill | mill | mill |
| | Form | | Slurry | Slurry | Slurry | Slurry | Slurry |
| Calcination | Calcination furnace | | Rotary kiln calcination furnace | | | | |
| | Highest temperature [° C.] | | 840 | 840 | 840 | 840 | 840 |
| | Retention time [min] | | 30 | 30 | 30 | 30 | 30 |
| Disintegration | Hammer mill disintegration | | Performed | Performed | Performed | Performed | Performed |
| | Treatment | Li salts | LTFSI + | LTFSI + | LTFSI + | LTFSI + | LTFSI + |
| | agent | | LFSI | LPF | LMS | LES | LiBOB |
| | | Molar ratio of Li salts | 50:50 | 99:01 | 99:01 | 99:01 | 99:01 |
| | | Organic solvent | TetraG | TetraG | TetraG | TetraG | TetraG |
| | | Molar ratio of Li | 50:50 | 50:50 | 50:50 | 50:50 | 50:50 |
| | | salt:organic solvent | | | | | |
| | | Amount added | 25 | 25 | 25 | 25 | 25 |
| | | [mass %] | | | | | |

### Example 1

### [Preparation of Negative Electrode Active Material Composition]

In a glove box under an argon atmosphere, the lithium titanate powder of Production Example 1 and the sulfide inorganic solid electrolyte powder (volume average particle diameter obtained using a laser diffraction/scattering particle size distribution analyzer: 6 μm) having a composition of Li₆PS₅Cl were weighed such that the mass ratio would be lithium titanate:Li₆PS₅Cl=60:40, and mixed in an agate mortar. Then, zirconia balls (diameter 3 mm, 20 g) were put into an 80 mL zirconia pot, and the mixed powder was also put into the pot. After that, this pot was set in a planetary ball mill, and stirring was continued for 15 minutes at a rotation speed of 200 rpm to obtain a negative electrode active material composition of Example 1.

### Examples 2 to 14 and Comparative Examples 1 to 4

Negative electrode active material compositions listed in Tables 3 to 6 below were prepared in the same manner as in Example 1 except that the lithium titanate powders produced by the methods listed in Tables 1 and 2 were used.

### [Evaluation of Battery Characteristics]

All-solid-state secondary batteries were prepared using the pellets of the negative electrode active material compositions of Examples, and their battery characteristics were evaluated. The results of evaluation are listed in Tables 3 to 6.

### [Synthesis of Sulfide-Based Inorganic Solid Electrolyte]

In a glove box under an argon atmosphere, lithium sulfide (Li₂S) and diphosphorus pentasulfide (P₂S₅) were weighed such that the molar ratio of Li₂S:P₂S₅ was 75:25, and mixed in an agate mortar. A raw material composition was thus obtained.

Then, zirconia balls (diameter 3 mm, 160 g) and 2 g of the obtained raw material composition were put into an 80 mL zirconia pot, and the container was sealed under an argon atmosphere. This pot was set in a planetary ball mill, and mechanical milling was performed at a rotation speed of 510 rpm for 16 hours to obtain a yellow powdery sulfide inorganic solid electrolyte (LPS glass). A pellet-shaped solid electrolyte layer was obtained by pressing 80 mg of the obtained LPS glass at a pressure of 360 MPa using a pellet molding machine having a molding part with an area of 0.785 cm².

[Preparation of all-Solid-State Secondary Battery]

The pellets of the negative electrode active material composition according to each of Examples, the above pellet-shaped solid electrolyte layer, and a lithium indium alloy foil as the counter electrode were laminated in this order, and the laminate was interposed between stainless steel current collectors. All-solid-state secondary batteries were thus prepared.

### <Measurement of Initial Discharge Capacity and Charge Rate Characteristics>

In a constant temperature bath at 25° C., each coin-type battery prepared by the above-described method was subjected to constant-current and constant-voltage charge with a direction of charge in which Li was absorbed in the electrode to be evaluated. In the constant-current and constant-voltage charge, the battery was charged to 0.5 V with a current corresponding to 0.05C, which is the theoretical capacity of lithium titanate, and further charged at 0.5 V until the charging current reached a current corresponding to 0.01C. After that, the battery was subjected to constant-current discharge so as to be discharged to 2 V with a current corresponding to 0.05C. The initial discharge capacity (mAh/g) was obtained by dividing the discharge capacity (mAh) by the mass of lithium titanate. Then, after charging the battery to 0.5 V with a current corresponding to 0.4C, which is the theoretical capacity of lithium titanate, the battery was discharged to 2 V with a current of 0.05C to obtain a 0.4C charge capacity. The rate characteristic (%) was calculated by dividing the 0.4C charge capacity by the initial discharge capacity. The initial discharge capacities and charge rate characteristics were examined as relative values with reference to respective values of Comparative Example 1 being 100%. The results of evaluation are listed in Tables 2 and 3. The C of 1C represents the current value when charging and discharging. For example, 1C refers to a current value that can fully discharge (or fully charge) the theoretical capacity in 1/1 hour, and 0.1C refers to a current value that can fully discharge (or fully charge) the theoretical capacity in 1/0.1 hour.

TABLE 3

| | | | | | | | Comparative |
|---|---|---|---|---|---|---|---|
| | | | Example 1 | Example 2 | Example 3 | Example 4 | Example 1 |
| Lithium | Production method | | Production | Production | Production | Production | Production |
| titanate | | | Example 1 | Example 2 | Example 3 | Example 4 | Example 7 |
| (LTO) | Specific surface area [m²/g] | | 7.1 | 7.1 | 7.1 | 6.8 | 7.1 |
| | Primary particles D50 [μm] | | 0.7 | 0.7 | 0.7 | 0.7 | 0.7 |
| | Metal | Type | — | — | — | Al | — |
| | element M | Content ratio | — | — | — | 0.13 | — |
| | | [mass %] | | | | | |
| | Ionic | Type | LTFSI − | LTFSI − | LTFSI − | LTFSI − | — |
| | liquid | | TetraG | TetraG | TetraG | TetraG | |
| | | Molar ratio of | 50:50 | 50:50 | 50:50 | 50:50 | — |
| | | Li salt:organic | | | | | |
| | | solvent | | | | | |
| | | Content ratio | 25 | 10 | 5 | 25 | — |
| | | [mass %] | | | | | |

| | | | | | | |
|---|---|---|---|---|---|---|
| Solid | Type | Li₆PS₅Cl | Li₆PS₅Cl | Li₆PS₅Cl | Li₆PS₅Cl | Li₆PS₅Cl |
| electrolyte | | | | | | |
| (SE) | | | | | | |

| | | | | | |
|---|---|---|---|---|---|
| LTO [mass %]:SE [mass %] | 60:40 | 60:40 | 60:40 | 60:40 | 60:40 |
| Initial discharge capacity [%] | 118.7 | 111.7 | 118.4 | 107.5 | 100.0 |
| Charge rate characteristics [%] | 133.2 | 118.2 | 103.8 | 119.7 | 100.0 |

TABLE 4

| | | | | Comparative | | Comparative |
|---|---|---|---|---|---|---|
| | | | Example 5 | Example 2 | Example 6 | Example 3 |
| Lithium | Production method | | Production | Production | Production | Production |
| titanate | | | Example 1 | Example 7 | Example 1 | Example 7 |
| (LTO) | Specific surface area [m²/g] | | 7.1 | 7.1 | 7.1 | 7.1 |
| | Primary particles D50 [μm] | | 0.7 | 0.7 | 0.7 | 0.7 |
| | Metal | Type | — | — | — | — |
| | element M | Content ratio | — | — | — | — |
| | | [mass %] | | | | |
| | Ionic | Type | LTFSI − | — | LTFSI − | — |
| | liquid | | TetraG | | TetraG | |
| | | Molar ratio of | 50:50 | — | 50:50 | — |
| | | Li salt:organic | | | | |
| | | solvent | | | | |
| | | Content ratio | 25 | — | 25 | — |
| | | [mass %] | | | | |

| | | | | | |
|---|---|---|---|---|---|
| Solid | Type | Li₆PS₅Cl | Li₆PS₅Cl | Li₆PS₅Cl | Li₆PS₅Cl |
| electrolyte | | | | | |
| (SE) | | | | | |

| | | | | |
|---|---|---|---|---|
| LTO [mass %]:SE [mass %] | 70:30 | 70:30 | 80:20 | 80:20 |
| Initial discharge capacity [%] | 111.6 | 100.0 | 729.4 | 100.0 |
| Charge rate characteristics [%] | 340.3 | 100.0 | 373.8 | 100.0 |

In Tables 3 and 4 above, Examples 1 to 6 of the all-solid-state secondary batteries using the negative electrode active material compositions of the present invention have excellent initial discharge capacities, and it is found that the charge rate characteristics can be further improved.

When setting the mass ratio to lithium titanate:Li₆PS₅Cl=60:40 using a composition in which the same sulfide inorganic solid electrolyte and the same solvate ionic liquid as in Example 1 were preliminarily mixed at the same content rate as described in Patent Document 2, the ionic conductivity of the mixture increased and the charge rate characteristics were improved (charge rate characteristic: 127.5%), but these were inferior to those when using the lithium titanate powder of Example 1, and the initial discharge capacity was lower (94%) than that of Comparative Example 1. This result is considered to be because a side reaction occurred between the solid electrolyte and the ionic liquid and the initial characteristics were therefore lower than those in Comparative Example 1 in which no ionic liquid was mixed. Moreover, when the composition described in Patent Document 2 was used, the active sites on the lithium titanate surface were not able to be completely inactivated, and it is thus considered that the improvement in the rate characteristics was inferior to that of Example 1.

### <Battery Characteristics Test at 45° C.>

Evaluation was performed in the same manner as in Example 1 except that the temperature in the constant temperature bath was set to 45° C. The charging rate characteristics at the high temperature were determined as follows. After charging the battery to 0.5 V with a current corresponding to 0.2C, which is the theoretical capacity of lithium titanate, the battery was discharged to 2 V with a current of 0.05C to obtain a 0.2C charge capacity. The charge rate characteristic (%) was calculated by dividing the 0.2C charge capacity by the initial discharge capacity. The results of evaluation are listed in Tables 5 and 6.

TABLE 5

| | | | | | | Comparative |
|---|---|---|---|---|---|---|
| | | | Example 7 | Example 8 | Example 9 | Example 4 |
| Lithium | Production method | | Production | Production | Production | Production |
| titanate | | | Example 1 | Example 5 | Example 6 | Example 7 |
| (LTO) | Specific surface area [m²/g] | | 7.1 | 7.1 | 7.1 | 7.1 |
| | Primary particles D50 [μm] | | 0.7 | 0.7 | 0.7 | 0.7 |
| | Metal | Type | — | — | — | — |
| | element M | Content ratio | — | — | — | — |
| | | [mass %] | | | | |
| | Ionic | Type | LTFSI − | LFSI − | LTFSI − | — |
| | liquid | | TetraG | TetraG | GBL | |
| | | Molar ratio of | 50:50 | 50:50 | 50:50 | — |
| | | Li salt:organic | | | | |
| | | solvent | | | | |
| | | Content ratio | 25 | 25 | 25 | — |
| | | [mass %] | | | | |

| | | | | | |
|---|---|---|---|---|---|
| Solid | Type | Li₆PS₅Cl | Li₆PS₅Cl | Li₆PS₅Cl | Li₆PS₅Cl |
| electrolyte | | | | | |
| (SE) | | | | | |

| | | | | |
|---|---|---|---|---|
| LTO [mass %]:SE [mass %] | 80:20 | 80:20 | 80:20 | 80:20 |
| (45° C.) Initial discharge capacity [%] | 227.7 | 230.7 | 179.2 | 100.0 |
| (45° C.) Charge rate characteristics [%] | 225.0 | 375.1 | 117.8 | 100.0 |

TABLE 6

| | | | Example 10 | Example 11 | Example 12 | Example 13 | Example 14 |
|---|---|---|---|---|---|---|---|
| Lithium | Production method | | Production | Production | Production | Production | Production |
| titanate | | | Example 8 | Example 9 | Example 10 | Example 11 | Example 12 |
| (LTO) | Specific surface area [m²/g] | | 7.1 | 7.1 | 7.1 | 6.8 | 7.1 |
| | Primary particles D50 [μm] | | 0.7 | 0.7 | 0.7 | 0.7 | 0.7 |
| | Metal | Type | — | — | — | — | — |
| | element M | Content ratio | — | — | — | — | — |
| | | [mass %] | | | | | |
| | Ionic | Type | LTFSI + | LTFSI + | LTFSI + | LTFSI + | LTFSI + |
| | liquid | | LFSI − | LPF − | LMS − | LES − | LiBOB − |
| | | | TetraG | TetraG | TetraG | TetraG | TetraG |
| | | Molar ratio of | 50:50 | 50:50 | 50:50 | 50:50 | 50:50 |
| | | Li salt:organic | | | | | |
| | | solvent | | | | | |
| | | Content ratio | 25 | 25 | 25 | 25 | 25 |
| | | [mass %] | | | | | |

| | | | | | | |
|---|---|---|---|---|---|---|
| Solid | Type | Li₆PS₅Cl | Li₆PS₅Cl | Li₆PS₅Cl | Li₆PS₅Cl | Li₆PS₅Cl |
| electrolyte | | | | | | |
| (SE) | | | | | | |

| | | | | | |
|---|---|---|---|---|---|
| LTO [mass %]:SE [mass %] | 80:20 | 80:20 | 80:20 | 80:20 | 80:20 |
| (45° C.) Initial discharge capacity [%] | 217.7 | 205.7 | 229.7 | 222.8 | 220.2 |
| (45° C.) Charge rate characteristics [%] | 310.1 | 349.5 | 281.1 | 299.8 | 269.3 |

In Tables 5 and 6 above, Examples 7 to 14 of the all-solid-state secondary batteries using the negative electrode active material compositions of the present invention have excellent initial discharge capacity even at 45° C., and it is found that the charge rate characteristics can be further improved.

In the case of lithium titanate:Li₆PS₅Cl=90:10, the lithium titanate prepared in Production Example 7 was not charged at 45° C. and did not operate as a battery. On the other hand, in the lithium titanate prepared in Production Example 1, the initial discharge capacity was 227.4% and the charge rate characteristic was 348.4% compared to Comparative Example 4 (in the case of lithium titanate: Li₆PS₅Cl=80:20). From this result, by using the lithium titanate of the present invention, high battery characteristics were able to be maintained even when the ratio of solid electrolyte in the mixture was very small.

### (Niobium Titanate)

### <Step of Preparing Raw Materials>

Nb₂O₅ (average particle diameter: 0.2 μm) and anatase-type TiO₂ (specific surface area: 10 m²/g) were weighed and mixed in a molar ratio of 1:1. This mixed powder was heat-treated at 1000° C. for 5 hours. Powder X-ray diffraction measurement was performed on the obtained calcined powder sample under conditions of a sampling interval of 0.01° and a scan rate of 2°/min. From the results of crystal structure analysis using the Rietveld method, it was confirmed that the synthesized sample was the targeted titanium-containing oxide of niobium titanate (TiNb₂O₇: Titanium niobium oxide, ICDD (PDF2010) PDF card 01-077-1374).

Niobium titanate (referred to as TNO, hereinafter) was prepared using the calcined powder obtained above as a base agent and surface-treated with a solvate ionic liquid using the same solvate ionic liquid and mixing step as in Production Example 1.

Evaluation was performed in the same manner as in Example 7 except for TNO surface-treated with the solvate ionic liquid prepared above. The initial discharge capacity of TNO surface-treated with the solvate ionic liquid was 144.6% of that of TNO without surface treatment, and the initial characteristics were improved. Furthermore, when TNO without surface treatment was used, charging at 0.2C was not possible, but by surface treatment with the solvate ionic liquid, charging became possible.

From the above results, the use of the negative electrode active material composition of the present invention can effectively suppress the side reaction between the active sites on the surface of the titanium-containing oxide and the solid electrolyte, and excellent battery characteristics can thereby be exhibited.

1. A titanium-containing oxide powder whose main component is a titanium-containing oxide represented by Li₄Ti₅O₁₂ or Ti_{1-X/2}Nb₂O_{7-X} (0≤X<2),
the titanium-containing oxide powder containing the titanium-containing oxide particles and a solvate ionic liquid,
the solvate ionic liquid comprising, a Li salt and an organic solvent.

2. The titanium-containing oxide powder according to claim 1, wherein D50 of primary particles corresponding to a volume accumulation of 50% in a volume-based particle size distribution of the titanium-containing oxide powder is 0.5 μm or more, wherein the volume-based particle size distribution is measured by a laser diffraction scattering method.

3: The titanium-containing oxide powder according to claim 1, wherein the titanium-containing oxide powder has a specific surface area of 1 m²/g or more and 10 m²/g or less.

4: The titanium-containing oxide powder according to claim 1, wherein Al is present on particle surfaces of the titanium-containing oxide powder.

5: The titanium-containing oxide powder according to claim 1, wherein the Li salt is at least one type of Li salt selected from a group consisting of LiPF₆, LiBF₄, LiN(SO₂F)₂, LiN(SO₂CF₃)₂, and LiN(SO₂C₂F₅)₂.

6: The titanium-containing oxide powder according to claim 1, wherein the Li salt comprises at least two types or more of Li salts selected from a group consisting of LiPF₆, LiBF₄, LiN(SO₂F)₂, LiN(SO₂CF₃)₂, and LiN(SO₂C₂F)₂.

7: The titanium-containing oxide powder according to claim 1, wherein the Li salt comprises at least one type of Li salt selected from a group consisting of LiPF₆, LiBF₄, LiN(SO₂F)₂, LiN(SO₂CF)₂, and LiN(SO₂C₂F₅)₂, and the Li salt further comprises at least one type of Li salt selected from a group consisting of a Li salt having an oxalic acid frame, a Li salt having a phosphoric acid frame, and a Li salt having an S═O group.

8: The titanium-containing oxide powder according to claim 1, wherein the organic solvent is an ether compound.

9: The titanium-containing oxide powder according to claim 1, wherein a molar ratio of the Li salt to the organic solvent is 0.3 or more and 2.5 or less.

10: The titanium-containing oxide powder according to claim 1, wherein a proportion of the solvate ionic liquid to the titanium-containing oxide powder is 0.1 mass % or more and 30 mass % or less.

11: A negative electrode active material composition comprising:
a titanium-containing oxide powder according to claim 1; and
an inorganic solid electrolyte having conductivity for metal ions belonging to Group 1 of Periodic Table.

12: The negative electrode active material composition according to claim 11, wherein the inorganic solid electrolyte is a sulfide inorganic solid electrolyte.

13: The negative electrode active material composition according to claim 11, wherein a content of the inorganic solid electrolyte is 1 mass % or more and 50 mass % or less in the negative electrode active material composition.

14: An all-solid-state secondary battery comprising a positive electrode layer, a negative electrode layer, and a solid electrolyte laver, wherein the negative electrode layer is a layer containing the negative electrode active material composition according to claim 11.
A titanium-containing oxide powder whose main component is a titanium-containing oxide represented by Li₄Ti₅O₁₂ or Ti_{1-X/2}Nb₂O_{7-X} (0≤X<2),
the titanium-containing oxide powder containing the titanium-containing oxide particles and a solvate ionic liquid,
the solvate ionic liquid comprising a Li salt and an organic solvent.
